(19) United States
(12) Patent Application Publication
(10) Pub. No.: US 2025/0015335 A1
(43) Pub. Date: Jan. 9, 2025

(54) BATTERY MANUFACTURING APPARATUS INCLUDING SUPPORT MEMBER AND BATTERY MANUFACTURING METHOD

(71) Applicant: SK On Co., Ltd., Seoul (KR)

(72) Inventor: Ja Kyung KOO, Daejeon (KR)

(21) Appl. No.: 18/762,668

(22) Filed: Jul. 3, 2024

(30) Foreign Application Priority Data
Jul. 7, 2023 (KR) 10-2023-0088697
Mar. 29, 2024 (KR) 10-2024-0043643

(51) Int. Cl. H01M 10/04; G06T 7/13

(52) U.S. Cl. CPC H01M 10/0409; G06T 7/13; H01M 10/0431; G06T 2207/10024

(57) ABSTRACT

A secondary battery manufacturing apparatus includes a stack table supporting a first surface of an electrode assembly including at least one positive electrode plate, at least one negative electrode plate, and a separator interposed between the positive electrode plate and the negative electrode plate and a transfer unit transferring the electrode assembly while moving relative to the stack table and including a pulling jig supporting the first surface of the electrode assembly or a second surface facing the first surface, wherein the transfer unit further includes a support member provided to support a portion of the first surface of the electrode assembly that is not supported by the pulling jig.

### CROSS-REFERENCE TO RELATED APPLICATION(S)

This patent document claims the priorities and benefits of Korean Patent Application Nos. 10-2023-0088697 filed on Jul. 7, 2023 and 10-2024-0043643 filed on Mar. 29, 2024, the disclosure of which is incorporated herein by reference in its entirety.

### TECHNICAL FIELD

The present disclosure relates to a secondary battery manufacturing apparatus including a support member and secondary battery manufacturing method.

### BACKGROUND

Unlike primary batteries, secondary batteries, which can be conveniently charged and discharged, have received a lot of attention as a power source for various mobile devices and electric vehicles.

The secondary battery may include a battery cell in which an electrode assembly formed by stacking a positive electrode plate, a negative electrode plate, and a separator or winding all thereof in a roll shape is accommodated inside a case. A plurality of battery cells may be stacked in a predetermined direction and accommodated in a battery module or battery pack.

Meanwhile, during a secondary battery manufacturing process, the electrode assembly may be transferred by a transfer unit, and a phenomenon may occur in which portion of the electrode assembly, for example, the separator, sags downwardly due to gravity. If the secondary battery manufacturing process is continuously performed with the sagging phenomenon occurring, defects in which the positive or negative electrode plate are exposed externally may occur.

Therefore, there is a need to research secondary battery manufacturing apparatus that may prevent sagging of separators, etc. during the secondary battery manufacturing process.

### SUMMARY

The present disclosure can be implemented in some embodiments to provide a secondary battery manufacturing apparatus capable of supporting a separator from sagging downwardly due to gravity.

The present disclosure can be implemented in some embodiments to provide a secondary battery manufacturing apparatus capable of effectively sensing the occurrence of folding of a separator.

The present disclosure can be implemented in some embodiments to provide a secondary battery manufacturing method capable of preventing a separator from sagging downwardly due to gravity.

Battery cells produced by the secondary battery manufacturing apparatus including the support member of the present disclosure may be widely applied in green technology fields, such as electric vehicles, battery charging stations, and solar power generation and wind power generation using batteries. In addition, a battery module including a cooling port of the present disclosure may be used in eco-friendly electric vehicles, hybrid vehicles, etc. to mitigate the effects of climate change by suppressing air pollution and greenhouse gas emissions.

In some embodiments of the present disclosure, a secondary battery manufacturing apparatus includes a stack table supporting a first surface of an electrode assembly including at least one positive electrode plate, at least one negative electrode plate, and a separator interposed between the at least one positive electrode plate and the at least one negative electrode plate; and a transfer unit transferring the electrode assembly while moving relative to the stack table and including a pulling jig supporting the first surface of the electrode assembly or a second surface facing the first surface, wherein the transfer unit further includes a support member provided to support a portion of the first surface of the electrode assembly that is not supported by the pulling jig.

The support member may be provided to be elevated toward the first surface.

The support member may be provided to support at least one end of the electrode assembly based on a first direction.

The support member may be provided to support an edge portion of the electrode assembly provided close to a second direction perpendicular to the first direction.

The transfer unit may be provided to enter or retreat with respect to the stack table in a first direction, and the stack table may include a table avoidance portion formed in a position corresponding to the support member in the first direction and provided in a shape open toward the support member to avoid interference with the support member.

The stack table may include a first table at least partially facing the support member in the first direction and including the table avoidance portion and a second table at least partially facing the pulling jig in the first direction.

The second table may be provided to be elevated toward the first surface of the electrode assembly, and the pulling jig may be provided to move toward the stack table to support the electrode assembly when the second table is lowered.

The secondary battery manufacturing apparatus may further include: a winding gripper supporting a portion of the electrode assembly that is not supported by the pulling jig, wherein the winding gripper is provided to be movable, relative to the transfer unit in a second direction perpendicular to the first direction.

The winding gripper may include a first grip body and a second grip body respectively supporting one end and the other end of the electrode assembly based on the first direction.

The winding gripper may include a gripper avoidance portion formed in a portion overlapping the support member and provided to avoid interference with the support member.

The secondary battery manufacturing apparatus may further include: a sensor unit acquiring image information of the first surface of the electrode assembly and determining whether the first surface is wrinkled or folded.

The sensor unit may include at least one of a color sensor or a vision camera, and determine whether the first surface is folded by tracking an edge of the first surface of the electrode assembly and comparing color values of a folded portion and other portions.

In some embodiments of the present disclosure, a secondary battery manufacturing method includes a placement operation of placing, on a stack table, an electrode assembly including at least one positive electrode plate, at least one negative electrode plate, and a separator interposed between the positive electrode plate and the negative electrode plate; and a withdrawal operation in which the transfer unit draws out the electrode assembly from the stack table, while the transfer unit moves relative to the stack table in a first direction, wherein the withdrawal operation includes: a first withdrawal operation in which the transfer unit advances toward the stack table in the first direction; a second withdrawal operation in which the transfer unit supports the electrode assembly; and a third withdrawal operation in which the transfer unit retreats from the stack table together with the electrode assembly based on the first direction.

The transfer unit may include a pulling jig supporting the electrode assembly and a support member supporting a portion of the electrode assembly that is not supported by the pulling jig, and, in the second withdrawal operation, the pulling jig and the support member may support the electrode assembly.

The stack table may include a first table facing the support member in the first direction and a second table facing the pulling jig in the second direction and provided to be elevated in a direction perpendicular to the first direction, and, in the first withdrawal operation, the second table may be lowered, and in the third withdrawal operation, the second table may move to be raised.

The secondary battery manufacturing method may further include: after the withdrawal operation, a winding operation in which a winding gripper supports the electrode assembly, while moving relatively toward the transfer unit, wherein the winding operation includes: a first winding operation in which the winding gripper approaches the transfer unit in a second direction perpendicular to the first direction; a second winding operation in which the winding gripper supports a portion of the electrode assembly that is not supported by the pulling jig; and a third winding operation in which the pulling jig and the support member release support of the electrode assembly and retreat from the winding gripper along the first direction.

In the first winding operation, the winding gripper may move in the second direction so as not to overlap the support member, and in the second winding operation, the winding gripper may be provided to move in the first direction so that the support member is disposed in a gripper avoidance portion.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating at least portion of a process of forming an electrode assembly during a secondary battery manufacturing process;

FIGS. 2A to 2C are schematic diagrams illustrating removing an electrode assembly from a seating table through a transfer unit according to an exemplary embodiment of the present disclosure;

FIGS. 3A to 3E are schematic diagrams of the process of FIGS. 2A to 2C viewed from the side;

FIGS. 4A to 4C are schematic diagrams illustrating transferring an electrode assembly drawn out through a transfer unit to a winding gripper according to an exemplary embodiment of the present disclosure;

FIGS. 5A to 5D are schematic diagrams of a transfer process of FIGS. 4A to 4C viewed from the side;

FIG. 6 is a schematic diagram illustrating a detection sensor sensing folding of a separator according to an exemplary embodiment of the present disclosure;

FIG. 7 is a flowchart illustrating a secondary battery manufacturing method according to an exemplary embodiment of the present disclosure;

FIG. 8 is a flowchart illustrating an exemplary embodiment of a withdrawal operation;

FIG. 9 is a flowchart illustrating an exemplary embodiment of a winding operation; and

FIG. 10 is a flowchart illustrating an exemplary embodiment of a seating operation.

### DETAILED DESCRIPTION

Prior to the description of the present invention, terms and words used in the present specification and claims to be described below should not be construed as limited to ordinary or dictionary terms, and should be construed in accordance with the technical idea of the present invention based on the principle that the inventors may properly define their own inventions in terms of terms in order to best explain the invention.

Also, the same reference numerals or symbols respectively illustrated in the attached drawings denote parts or elements that perform the actually same functions. For convenience of description and understanding, the parts or elements will be described by using the same reference numerals or symbols even in different exemplary embodiments.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions such as an upper side, a lower side, a side face, a rear surface, and the like, are described based on the drawings and may be expressed differently when the direction of the corresponding object is changed.

The terms including ordinal numbers such as ‘first’, ‘second’, etc. may be used herein to distinguish elements from one another. These ordinal numbers are merely used to distinguish the same or similar elements from one another, and meanings of the terms are not construed as being limited by the using of the ordinal numbers. For example, use orders or arrangement orders of elements combined with these ordinal numbers are not limited by numbers thereof. The ordinal numbers may be replaced with one another.

The present disclosure will be described in detail with reference to the accompanying drawings. However, this is merely illustrative and the present disclosure is not limited to the specific embodiments described by way of example.

First, before describing a secondary battery manufacturing apparatus and a secondary battery manufacturing method using the same according to the present disclosure, a manufacturing process of an electrode assembly will be briefly described.

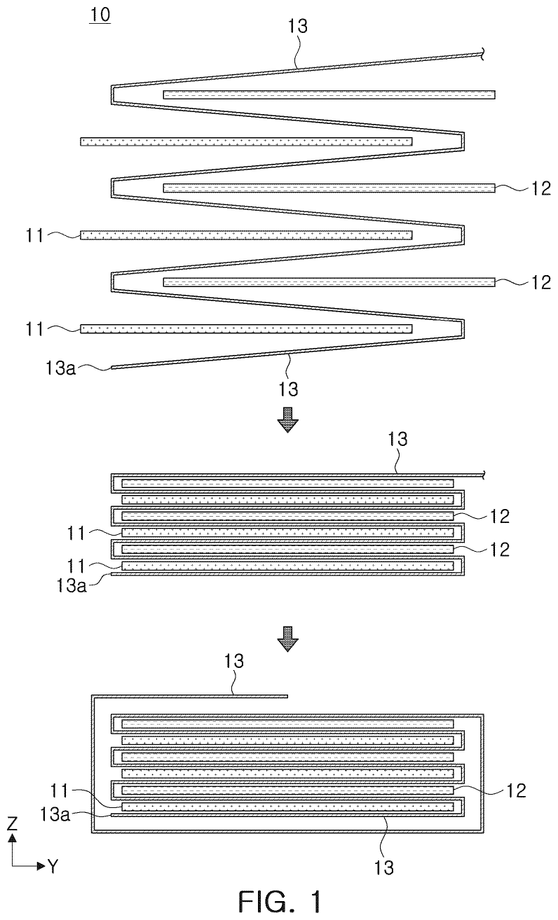

FIG. 1 is a schematic diagram illustrating at least portion of a process of forming an electrode assembly during a secondary battery manufacturing process.

Referring to upper and middle drawings of FIG. 1, an electrode assembly 10 may be configured in the form in which a positive electrode plate 11 and a negative electrode plate 12 are stacked in a state in which large surfaces thereof face each other with a separator 13 therebetween. A process of stacking the positive electrode plate 11, the separator 13, and the negative electrode plate 12 is performed in various manners, such as stacking type, zigzag folding type (Z-folding type), stack-folding type, etc.

The separator 13 may be configured to prevent an electrical short circuit between the positive electrode plate 11 and the negative electrode plate 12 and to generate flow of ions. As an example, the separator 13 may include a porous polymer film or a porous non-woven fabric.

Referring to the lower drawing of FIG. 1, the electrode assembly 10 stacked with the aforementioned structure is a jelly-roll type formed in a winding manner in a predetermined direction and may be accommodated in a case in various manners.

A battery cell manufactured by the secondary battery manufacturing apparatus of the present disclosure may be a pouch-type, prismatic-type, or cylindrical-type secondary battery depending on the structure of a case accommodating the electrode assembly 10.

Meanwhile, in the present disclosure, a state before winding is performed (see the middle drawing of FIG. 1) may be referred to as a “stack,” and a state after winding is performed (see the lower drawing of FIG. 1) may be referred to as an “electrode assembly.” However, this is simply for convenience, and one or more stack structures in which the separator 13 is disposed between the positive electrode plate 11 and the negative electrode plate 12 may be called the electrode assembly 10 (see FIG. 1).

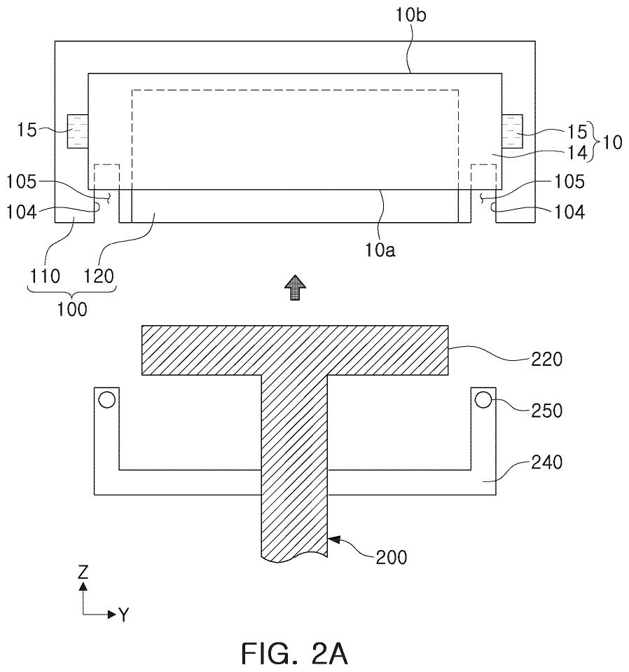

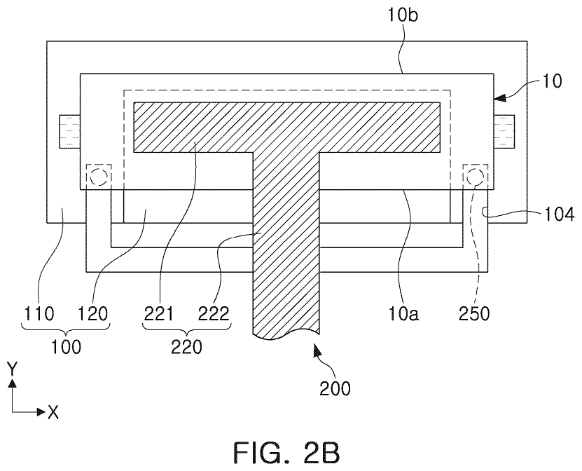

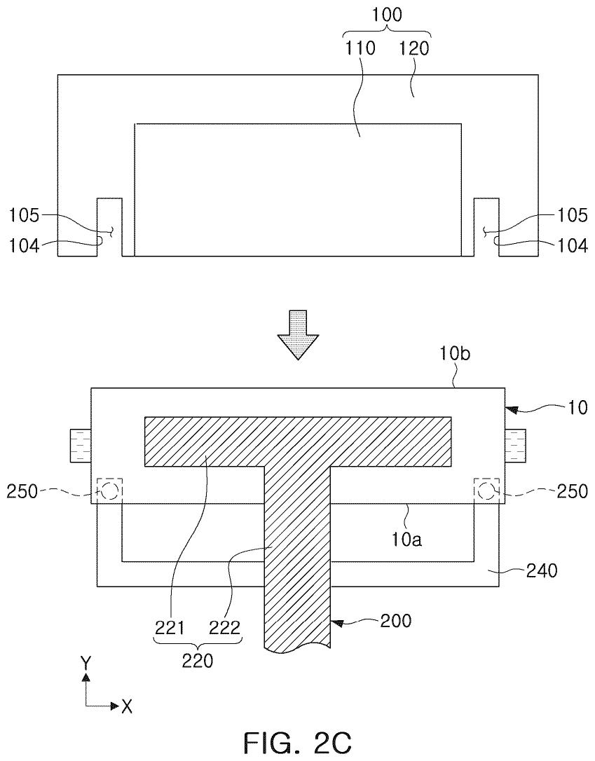

In addition, referring to FIG. 2A in advance, a portion in which the positive electrode plate 11, the separator 13, and the negative electrode plate 12 are stacked in order may be referred to as a body portion 14. The electrode assembly 10 may further include an electrode lead 15 extending in a longitudinal direction (an X-axis direction) of the body portion 14. The electrode lead 15 may be formed by punching out uncoated portions of the positive electrode plate 11 and the negative electrode plate 12 in a tab shape in which an active material is not applied and welding them to each other using ultrasonic welding or the like.

As shown in the drawing, the electrode lead 15 may extend to both sides in a longitudinal direction (X-axis direction). The electrode lead 15 disposed on one side (−X axis direction) of the body portion 14 and the electrode lead 15 disposed on the other side (+ axis direction) may have different electrical polarities. For example, the electrode lead 15 disposed on one side may be an electrode lead 15 formed from the positive electrode plate 11, and the electrode lead 15 disposed on the other side may be an electrode lead formed from the negative electrode plate 12.

Referring back to the upper drawing of FIG. 1, in the stacking process of the present disclosure, one end 13a of the separator 13 may be continuously provided in a zigzag manner by a roller or the like. That is, the separator 13 may be disposed on the outermost side to surround the positive electrode plate 11 and the negative electrode plate 12. In this manner, the separator 13 may be disposed on a lower surface of the electrode assembly 10.

When the electrode assembly 10 is raised through a pulling device or the like during the secondary battery manufacturing process, one end 13a of the separator 13 may sag downwardly due to gravity. If sagging of the separator 13 occurs, the separator 13 sagging during the secondary battery manufacturing process may partially folded and the positive electrode plate 11 or the negative electrode plate 12 may be exposed externally.

Meanwhile, since the other end of the separator may be provided in a folded shape as shown in the drawing, sagging occurs relatively less than the one end 13a, and even if sagging occurs, the possibility in which the positive electrode plate 11 or the negative electrode plate 12 is exposed externally may be reduced. In other words, the sagging phenomenon at one end (13a, one end of the separator that is first provided) of the separator 13 may be more severe than at the other end.

In other words, one end 10a of the electrode assembly 10 may sag more than the other end 10b, the lower surface of the electrode assembly 10 may sag more than the upper surface, and sagging may be more severe at the edge portion (i.e., the edge portion of the electrode assembly 10) adjacent to the electrode lead 15 than at the center portion of the body portion 14.

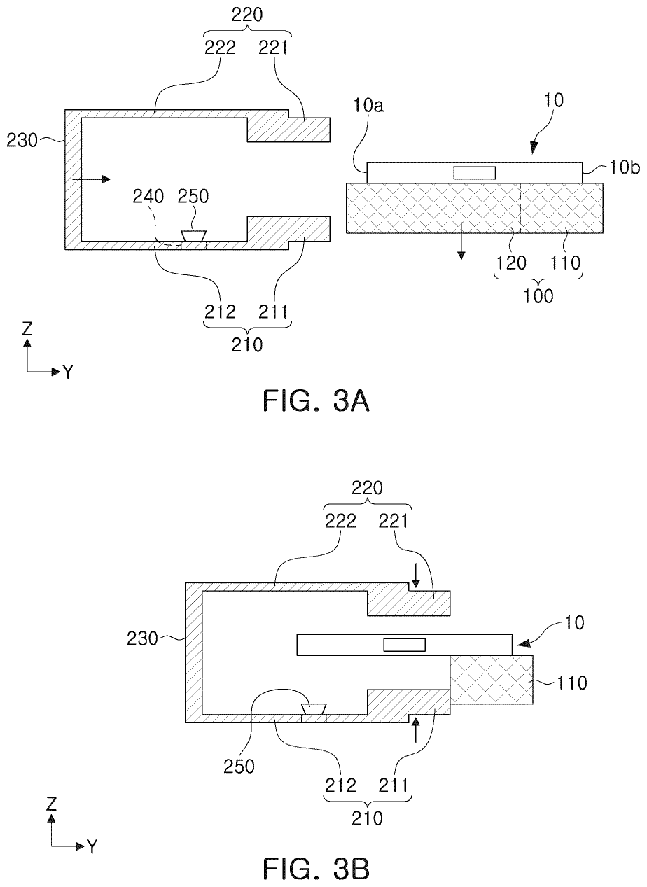

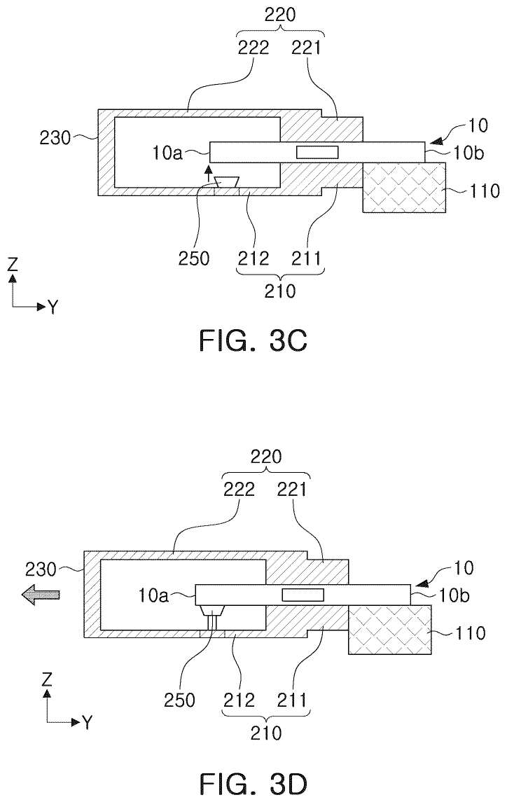

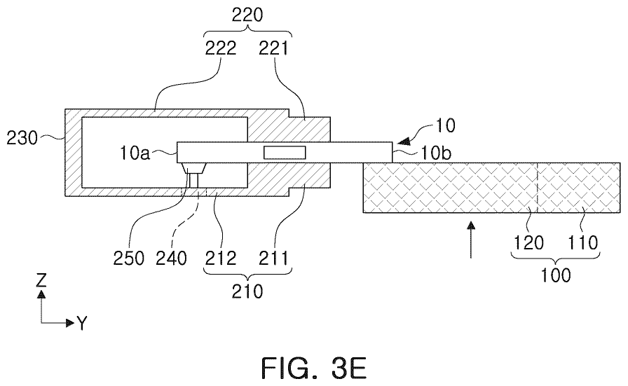

Hereinafter, a stack table and a transfer unit according to an exemplary embodiment of the present disclosure will be described with reference to FIGS. 2 and 3.

FIG. 2A is a diagram illustrating a transfer unit 200 approaching a stack table 100 on which the electrode assembly 10 is seated according to an exemplary embodiment of the present disclosure, and FIG. 2B illustrates the transfer unit 200 approaching the stack table 100 to support the electrode assembly 10, and FIG. 2C is a diagram illustrating the transfer unit 200, in a state of supporting the electrode assembly 10, retreating from the stack table. In addition, FIG. 3A is a diagram of FIG. 2A viewed from the side, FIGS. 3B to 3D are diagrams of FIG. 2B viewed from the side, and FIG. 3E is a diagram of FIG. 2C viewed from the side.

Referring to FIGS. 2 and 3 together, the manufacturing apparatus according to an exemplary embodiment of the present disclosure includes the stack which the electrode assembly 10 formed by sequentially stacking one or more positive electrode plates 11, one or more negative electrode plates 12, and the separator 13 interposed between the positive electrode plates 11 and the negative electrode plates 12 and the transfer unit 200 supporting at least a portion of a first surface (e.g., a lower surface) of the electrode assembly 10 and removing the electrode assembly 10 from the stack table 100 or seating the electrode assembly 10 on the stack table 100. Here, the transfer unit 200 may further include a support member 250 supporting one edge of the first surface (e.g., the lower surface) of the electrode assembly 10.

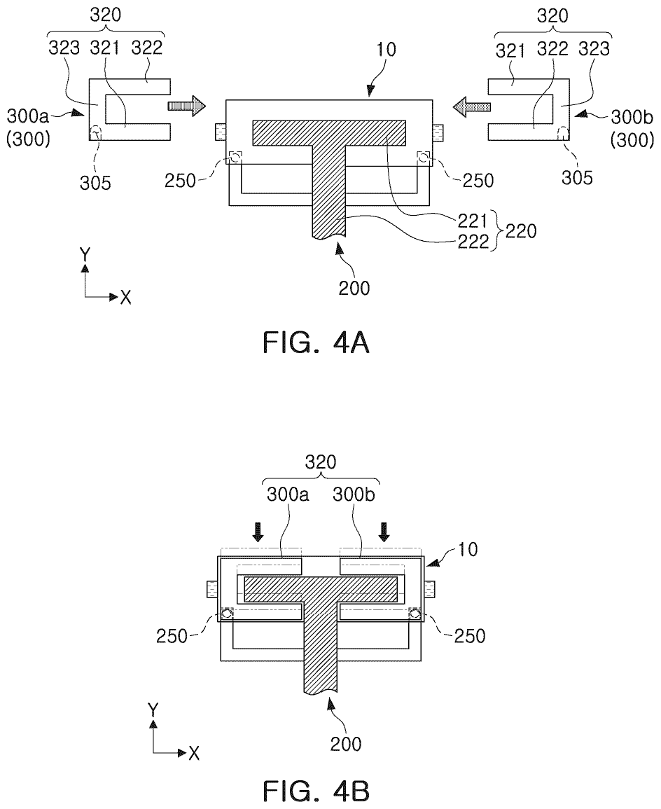

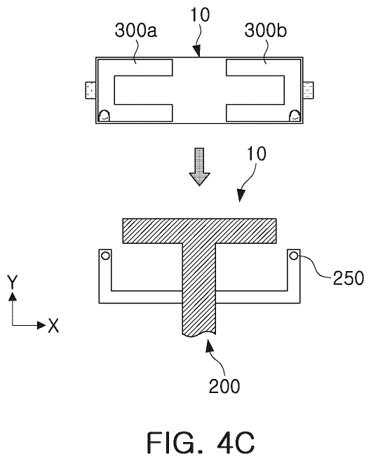

Meanwhile, in the secondary battery manufacturing process of the present disclosure, in the stacking process, the electrode assembly 10 may be formed such that the positive electrode plate 11 and the negative electrode plate 12 with separator 13 interposed therebetween are sequentially stacked on the stack table 100. After the stacking process, the outermost portion of the electrode assembly 10 may be wrapped with the separator 13, while the electrode assembly 10 is rotated by 180 degrees or more about an axis parallel to the longitudinal direction (X-axis direction) using a winding gripper 300 (see FIG. 4), and thereafter, the separator 13 may be cut to be finished.

The transfer unit 200 transfers the electrode assembly 10 from the stack table 100 to the winding gripper 300 or from the winding gripper 300 to the stack table 100. Here, if the transfer unit 200 does not support a weak portion of the electrode assembly 10 described above, the lower surface (specifically, the separator 13) may mainly sag by gravity, while the electrode assembly 10 is being transferred through the transfer unit 200. If the winding process or the like is performed with such sagging occurring, the sagging portion may be folded to cause a defect, that is, the positive electrode plate 11 or the negative electrode plate 12 may be exposed externally. The support member 250 may support the lower surface of the electrode assembly 10 described above to minimize sagging.

The stack table 100 may be a structure supporting the stack, when the stack (or the electrode assembly 10) is formed (see the middle drawing of FIG. 1) by sequentially stacking the positive electrode plate 11, the separator 13, and the negative electrode plate 12 during the secondary battery manufacturing process.

The stack table 100 may be provided with a structure capable of supporting the entire lower surface of the electrode assembly 10 so that the electrode assembly 10 may not sag due to gravity. For example, the region of the stack table 100 may be equal to or larger than the region of the lower surface of the electrode assembly 10.

The stack table 100 may include a first table 110 supporting a portion of the electrode assembly 10 and a second table 120 supporting the other portion of the electrode assembly 10 and provided to be elevated in a height direction (a stacking direction or a Z axis direction of the electrode assembly 10) to avoid interference when the transfer unit 200 enters (see FIGS. 3A and 3B).

Among the first table 110 and the second table 120, the second table 120 may support the center of the electrode assembly 10, and the first table 110 may support the edge of the electrode assembly 10 excluding the center. Meanwhile, in the drawing, the first table 110 is provided in a shape like ‘[’, but this is for convenience of understanding, and the present disclosure is not limited thereto. For example, the first table 110 may be provided in a square-like structure, such as ‘□’.

The first table 110 has a table avoidance portion 105 formed by a notch portion 104 to avoid interference with the support member 250 (see FIGS. 3C and 3D), which will be described later, when the transfer unit 200 enters. The support member 250, which will be described later, may support the electrode assembly 10 by entering the table avoidance portion 105 (see FIG. 2B).

The table avoidance portion 105 may be located close to at least one end of the electrode assembly 10 when the electrode assembly 10 is seated on the stack table 100. For example, the table avoidance portion 105 may be placed close to one end 10a of the electrode assembly 10. One end 13a of the separator 13 may be disposed on one end 10a of the electrode assembly 10, as described above in FIG. 1. That is, the table avoidance portion 105 may be disposed at one end 10a portion of the electrode assembly 10 so that the support member 20 may support the one end 13a of the separator 13.

As described later in FIGS. 2C and 3E, the table avoidance portion 105 may be provided in an open shape in a retreat direction (−Y axis direction) of the transfer unit 200 so that the raised support member 250 supporting the electrode assembly 100 may be released from the transfer table 100.

In addition, the table avoidance portion 105 may be disposed close to an edge portion (the edge in the X-axis direction) of one end 10a of the electrode assembly 10 in order to effectively prevent the separator 13 from sagging.

Here, the “edge portion of the electrode assembly 10” may refer to an edge in the longitudinal direction (X-axis direction). In other words, it may refer to a portion supported by the first table 110 as a portion close to both sides in the longitudinal direction (X-axis direction) of the region occupied by the electrode assembly 10 based on the X-Y axis plane of FIG. 2A.

Also, the “edge portion of one end 10a of the electrode assembly 10” may refer to a portion in which one end (a) of the electrode assembly 10 and the edge portion of the electrode assembly 10 described above based on one side of the X-Y axis overlap each other. For example, in FIG. 2A, it may refer to the surrounding region including the portion in which the table avoidance portion 105 is formed.

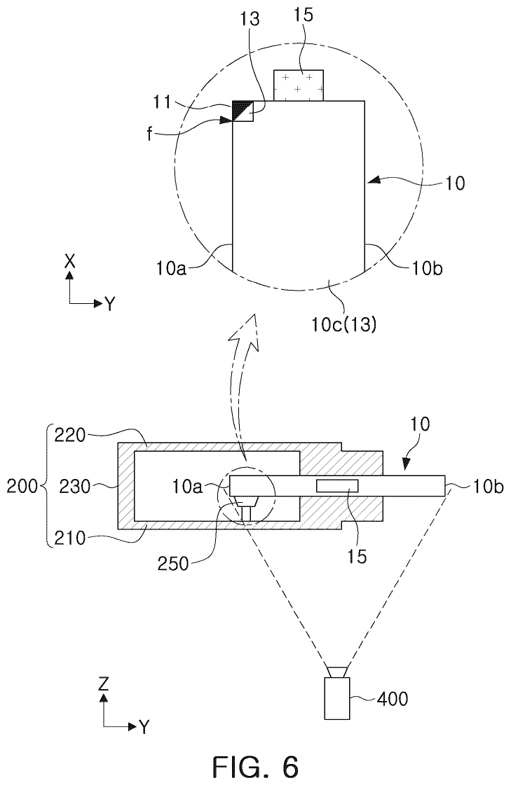

In particular, the above-mentioned portion may be referred to as a “weak portion of the electrode assembly 10” because it is a point at which the sagging phenomenon is severe due to gravity. The secondary battery manufacturing apparatus of the present disclosure may minimize the occurrence of separator folding (f, see FIG. 6) by supporting the weak portion of the electrode assembly 10 through the support member 250.

That is, according to the present disclosure, the weak portion of the electrode assembly 10 described above may be continuously supported during the secondary battery manufacturing process.

Meanwhile, the table avoidance portion 105 of the present disclosure may be disposed close to the other end 10b of the electrode assembly 10. However, tension may be applied to the other end 10b of the electrode assembly 10 due to the stacking of the separator 13 differently from one end 10a. That is, since the lower surface of the other end 10b is at least partially surrounded by the separator 13, sagging may occur less than that of one end 10a (see the middle drawing of FIG. 1).

The second table 120 may be elevated in a direction (Z-axis direction) perpendicular to the entry direction (Y-axis direction) of the transfer unit 200 to prevent interference when the transfer unit 200, which will be described later, enters. (FIGS. 3A and 3E)

The transfer unit 200 (or a pulling portion) is a structure that transfers the electrode assembly 10 seated on the stack table 100 to the winding device 300 (see FIG. 4A), which will be described later, or vice versa, during the secondary battery manufacturing process.

Referring to FIGS. 2 and 3, the transfer unit 200 may advance toward the stack table 100 and retreat to remove the electrode assembly 10 from the stack table 100.

The transfer unit 200 includes a first pulling jig 210 and a second pulling jig 220 arranged to face each other and a connection jig 230 connecting the pulling jigs 210 and 220 to each other and adjusting a distance therebetween. The first pulling jig 210 and the second pulling jig 220 may transfer the electrode assembly 10 toward or away from each other in the direction (Z-axis direction) in which they face each other with the electrode assembly 10 disposed therebetween. The first pulling jig 210 may support an upper surface (a second surface) of the electrode assembly 10, and the second pulling jig 220 may support the lower surface (the first surface) of the electrode assembly 10.

In other words when, among the regions of the electrode assembly 10, a portion supported by the first table 110 is referred to as a first support region, a portion supported by the second table 120 is referred to as a second support region, and a portion supported by the pulling jigs 210 and 220 is referred to as a pooling region, the pooling region may overlap the second support region. However, the support member 250, which will be described later, may not overlap all of the first support region, the second support region, and the pooling region.

The first pulling jig and the second pulling jig 210 and 220 may include support portions 211 and 221 supporting the electrode assembly 10 and extension portions 212 and 222 extending from the support portions 211 and 221 to the connection jig 230, respectively.

The support portion 211 of the first pulling jig 210 and the support portion 221 of the second pulling jig 220 may support the portion of the electrode assembly 10 supported by the second table 120. Meanwhile, the sum of the area of the support portions 211 and 222 and the area of the winding gripper 300, which will be described later, may correspond to the area of the electrode assembly 10 (see FIG. 4B).

Meanwhile, when the electrode assembly 10 is seated on the stack table 100, all portions including one end 10a may be supported by the first table 110 and the second table 120 (see FIG. 2A), but when the electrode assembly 10 is taken out from the stack table 100 and supported by the pulling jigs 210 and 220, one end 10a portion, especially, the edge portion of one end 10a (see FIG. 2C) may not be properly supported (See FIG. 2C).

Accordingly, the transfer unit 200 of the present disclosure may further include the support portion 250 capable of supporting one end 10a portion of the electrode assembly 10 described above, specifically, the edge portion, which is one end 10a supported by the first table 110.

The support member 250 may be provided to support at least a portion of the electrode assembly 10 that is not supported by the pulling jigs 210 and 220. In other words, the support member 250 may support a portion that is not supported by the pulling jigs 210 and 220 and the second table 120. In addition, since the table avoidance portion 105 overlapping the support member 250 in the height direction (Z-axis direction) is disposed on the first table 110, the support member 250 may support a portion not supported by the first table 110.

In other words, the support member 250 may support a portion of the electrode assembly 10 that is not supported by both the stack table 100 and the pulling jigs 210 and 220. That is, the support member 250 may support one end 10a of the electrode assembly 10, especially, the edge portion.

In addition, the support member 250 may be provided to be elevated in the height direction (Z-axis direction) perpendicular to the entry direction (Y-axis direction) of the transfer unit 200. The support member 250 may support the electrode assembly 10 while the transfer unit 200 moves toward the stack table 100 or while the transfer unit 200 is elevated upon completion of entry (see FIG. 3D).

Meanwhile, in the drawing, the support member 250 is shown as a pin-shaped structure, but this is only an example and may be provided in various shapes, such as a pad shape. That is, there is no particular limitation as long as the structure may support the electrode assembly 10 through the table avoidance portion 105. In addition, the support member 250 is shown as supporting one end 10a of the electrode assembly 10, but is not limited thereto and may be provided to support the other end 10b as well.

In addition, the transfer unit 200 may further include a support extension portion 240 supporting the support member 250. However, the support extension portion 240 in the drawing is for convenience of understanding, and if the support member 250 has a structure that may be located in the table avoidance portion 105 of the stack table 100, the support member 250 may be formed in the pulling jig 210 and 220.

Hereinafter, a process of withdrawing the electrode assembly through the transfer unit will be described with reference to FIGS. 2 and 3.

Referring to FIGS. 2A and 3A together, the electrode assembly 10 may be seated across the first table 110 and the second table 120 of the stack table 100. While the transfer unit 200 moves toward the stack table 100, the second table 120 may be lowered in the height direction (Z-axis direction) to avoid interference with the pulling jigs 210 and 220, and only the first table 110 may support the electrode assembly 10.

At this time, since the edge portion of one end 10a of the electrode assembly 10 is supported by the first table 110, end 10a of the electrode assembly 10 may be prevented from being folded.

In addition, while the transfer unit 200 moves, the pulling jigs 210 and 220 may enter the portion supported by the second table 120, and the support member 250 may move toward the table avoidance portion 105.

Referring to FIGS. 2B and 3A to 3D together, in a state in which the transfer unit 200 has entered, the pulling jigs 210 and 220 may move closer to each other in the height direction and allow the electrode assembly 10 to be inserted therebetween. At this time, the support member 250 may move upwardly in the height direction and pass through the table avoidance portion 105 to support one end 10a of the electrode assembly 10, specifically, the edge portion of one end 10a.

Meanwhile, in the drawing, for convenience of understanding, the support member 250 is illustrated to be raised after the second pulling jig 220 is raised. However, the present disclosure is not limited thereto, and the second pulling jig 220 and the support member 250 may be elevated together.

Referring to FIGS. 3C and 3E together, when the pulling jigs 210 and 220 and the support member 250 all support the electrode assembly 10, the transfer unit 200 may retreat, and through this, the electrode assembly 10 may be withdrawn from the table 100. In addition, when the pulling jigs 210 and 220 are released, the second table 120 which has been lowered may be raised again to be placed at the same height as the first table 110.

Meanwhile, the secondary battery manufacturing apparatus of the present disclosure may include the winding gripper 300 rotating the electrode assembly 10 to wind the separator 13 around the electrode assembly 10.

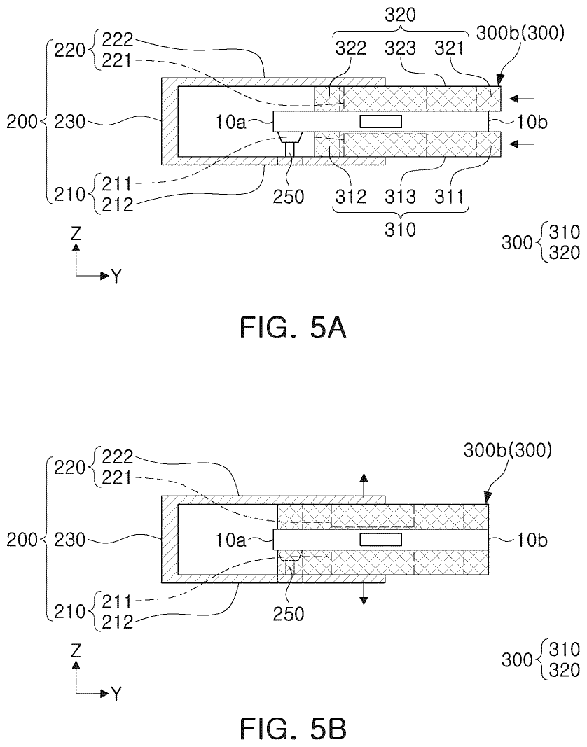

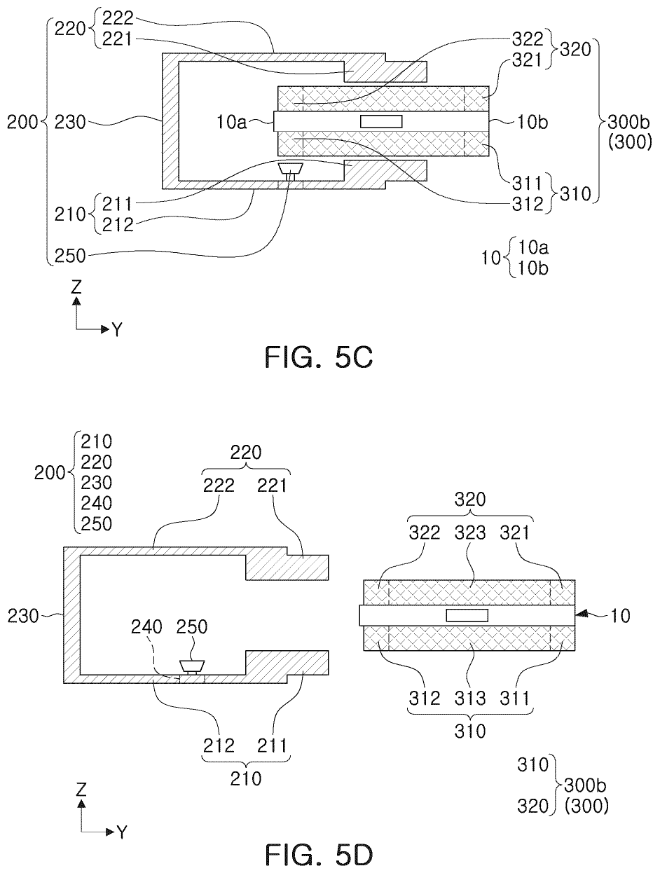

Hereinafter, the transfer unit 200 and the winding gripper 300 of the present disclosure will be described with reference to FIGS. 4 and 5.

FIG. 4A is a diagram illustrating that the winding grippers 300 approaches the pulling jigs 210 and 220 of the transfer unit 200 from both sides, FIG. 4B illustrates the winding gripper moving in a direction perpendicular to the approach direction to avoid interference with the support member 250, and FIG. 4C is a diagram illustrating the transfer unit 200 retreating to escape from the winding gripper 300. In addition, FIG. 5A is a side view of FIG. 4B, and FIGS. 5B to 5D are side views of FIG. 4C.

Referring to FIGS. 4 and 5 together, the winding gripper 300 may rotate the electrode assembly 10 by 180 degrees or more so that the separator is wrapped around the outermost portion of the electrode assembly 10 (see the lower drawing of FIG. 1). That is, the winding gripper 300 may rotate the electrode assembly 10 while supporting both the upper and lower surfaces of the electrode assembly 10 transferred through the transfer unit 200.

The winding gripper 300 may be provided to support portions not supported by the pulling jigs 210 and 220 (see FIG. 4B). That is, when the surface supported by the winding gripper 300 is referred to as a winding grip region, the pulling region may not overlap the winding grip region. In addition, the winding grip region may be disposed to overlap at least one of the first support region and the second support region.

In the drawing, the winding gripper 300 may be provided in a shape of ‘[’ surrounding the pulling jigs 210 and 220 and support both the upper surface (the second surface) and the lower surface (the first surface) of the electrode assembly 10. The winding gripper 300 may approach the electrode assembly 10 in a direction parallel to the electrode lead 15 formed on the electrode assembly 10.

Meanwhile, as long as the winding gripper 300 has a structure capable of supporting at least a portion of the electrode assembly 10 that is not supported by the pulling jig 210 and 220, the shape, number, driving direction, etc. thereof are not particularly limited. For example, in FIG. 4A, the winding gripper 300 is illustrated to approach from both sides by including a first winding gripper 300a and a second winding gripper 300b of the electrode assembly 10, but this is only an example, and only any one of the first winding gripper 300a or the second winding gripper 300b may also be provided.

The first winding gripper 300a and the second winding gripper 300b are divided for convenience in the direction in which they are arranged based on the electrode assembly 10, and detailed configurations thereof may be the same, and the first winding gripper 300a and the second winding gripper 300b may be used interchangeably as the winding gripper 300.

The winding gripper 300 may be provided with a structure capable of supporting at least a portion of the lower surface (first surface) and the upper surface (second surface) of the electrode assembly 10, respectively. For example, the winding gripper 300 may include a first grip portion 310 supporting the lower surface of the electrode assembly 10 and a second grip portion 320 supporting the upper surface of the electrode assembly 10 (see FIG. 5A).

In addition, the first grip portion 310 and the second grip portion 320 may each include first grip bodies 311 and 321 supporting one end 10a of the electrode assembly 10, second grip bodies 312 and 322 supporting the other end 10b, and third grip bodies 313 and 323 connecting the first grip bodies 311 and 321 and the second grip bodies 312 and 322.

The first grip body 311 of the first grip portion 310 and the first grip body 321 of the second grip portion 320 may be arranged to face each other and may support one end 10a of the electrode assembly 10. The second grip body 312 of the first grip portion 310 and the second grip body 322 of the second grip portion 320 may be arranged to face each other and may support the other end 10b of the electrode assembly 10. In addition, the third grip body 313 of the first grip portion 310 and the third grip body 323 of the second grip portion 320 may support the edge portion of the electrode assembly 10, that is, a portion close to the electrode lead 15.

In addition, the winding gripper 300 may further include a gripper avoidance portion 305 that may avoid interference with the support member 250 when moving toward the electrode assembly 10. The gripper avoidance portion 305 may be disposed to overlap the support member 250 when the winding gripper 300 supports the upper and lower surfaces of the electrode assembly 10 (see FIGS. 4B and 5B). Since the support member 250 is provided to support the lower surface of the electrode assembly 10, the gripper avoidance portion 305 may be formed in the first grip portion 310 supporting the lower surface of the electrode assembly 10.

The support member 250 may support the edge portion of one end 10a of the lower surface of the electrode assembly 10, that is, a weak portion, in which sagging phenomenon may occur intensively due to the influence of gravity. Accordingly, the gripper avoidance portion 305 may be formed in the first grip portion 310 supporting the lower surface of the electrode assembly 10. In particular, the gripper avoidance portion 305 may be formed in the first grip body 311 of the first grip portion 310 supporting one end 10a.

In addition, as will be described later, the winding gripper 300 moves toward the support member 250 (−Y-axis direction), so the gripper avoidance portion 305 may be provided to be open in the −Y-axis direction to avoid interference.

Hereinafter, a process in which the electrode assembly 10 is transferred to the winding gripper 300 during the secondary battery manufacturing process of the present disclosure is described with reference to FIGS. 4 and 5.

Referring to FIG. 4A, the winding gripper 300 may enter in the longitudinal direction (X-axis direction or the direction in which the electrode lead 15 is formed) of the electrode assembly 10.

Meanwhile, at this time, since the support member 250 is in a raised state, interference with the winding gripper 300 may occur. Therefore, according to an exemplary embodiment of the present disclosure, when entering in the longitudinal direction (X-axis direction) of the electrode assembly 10, the winding gripper 300 may be inclined in a direction (Y-axis direction) perpendicular to the support member 250 to avoid interference with the support member 250.

That is, when the winding gripper 300 enters, the winding gripper 300 may not overlap the support member 250 in the longitudinal direction (X-axis direction) of the electrode assembly 10.

Referring to FIGS. 4B, 5B, and 5C together, the winding gripper 300 may enter the electrode assembly 10 in the longitudinal direction (X-axis direction) and then move in a direction (−Y-axis direction) perpendicular to the electrode assembly 10.

Specifically, the winding gripper 300 may enter in the longitudinal direction (X-axis direction) until the gripper avoidance portion 305 overlaps the support member 250 in the width direction (Y-axis direction) of the electrode assembly 10.

When the gripper avoidance portion 305 and the support member 250 are arranged to overlap in the width direction (Y-axis direction) of the electrode assembly 10, the winding gripper 300 may support the electrode assembly 10, while moving in a direction (−Y axis direction) toward the support member 250. That is, the support member 250 may be disposed on the gripper avoidance portion 305.

Referring to FIGS. 4C and 5D together, while the winding gripper 300 supports both the upper and lower surfaces of the electrode assembly 10, the transfer unit 200 may escape from the winding gripper 300, while moving in the −Y-axis direction.

Specifically, the pulling jigs 210 and 220 may be open in a direction in which the pulling jigs 210 and 220 are away from each other in the height direction (Z-axis direction), and the support member 250 may be lowered downwardly. Thereafter, the transfer unit 200 may retreat and escape from the winding gripper 300.

Through FIGS. 2 to 5, it can be seen that the electrode assembly 10 mounted on the stack table 100 are continuously supported at one end 10a by the support member 250 until the electrode assembly 10 is transferred to the winding gripper 300. That is, in the present disclosure, by continuously supporting one end 10a of the electrode assembly 10, especially, the edge portion of one end 10a, through the support member 250, the table avoidance portion 105, and the gripper avoidance portion 305, the separator 13 of the electrode assembly 10 may be effectively prevented from being folded.

Meanwhile, through FIGS. 2 to 5, a structure in which the electrode assembly 10 is sequentially transferred from the stack table 100 to the transfer unit 200 and the winding gripper 300 has been described, but the electrode assembly 10 may also be transferred in the opposite direction. That is, the electrode assembly 10 may be sequentially moved from the winding gripper 300 to the transfer unit 200 and the stack table 100, and the detailed order may be the reverse of the order described in FIGS. 2 to 5.

In addition, the secondary battery manufacturing apparatus of the present disclosure may further include a sensor unit 400 capable of sensing that a folding phenomenon occurs in the electrode assembly 10.

FIG. 6 is a schematic diagram illustrating a detection sensor sensing that the separator is folded according to an exemplary embodiment of the present disclosure.

Referring to FIG. 6, in the electrode assembly 10, sagging occurs mainly on the lower surface 10c due to gravity. Referring back to FIG. 1, the lower surface 10c of the electrode assembly 10 may be the separator 13. In other words, it may be sufficient for the sensor unit 400 to have a structure capable of detecting the lower surface 10c of the electrode assembly 10. In particular, it is sufficient to have a structure capable of detecting at least one end 10a of the electrode assembly 10, especially, an edge portion (a portion supported by the support member 250) in which folding of the separator 13 is likely to occur.

The sensor unit 400 may detect folding of the lower surface 10c of the electrode assembly 10, specifically, the separator 13. When the sensor unit 400 detects sagging or a folded portion of the separator 13, the sensor unit 400 may generate a defect occurrence signal. When the defect occurrence signal is generated, an operator may take action, such as discarding the electrode assembly 10 in question, thereby preventing defective battery cells from being manufactured.

For example, the sensor unit 400 may include at least one of a color sensor or a vision camera.

When the sensor unit 400 includes a color sensor, the sensor unit 400 may extract color information from an image of a subject (the lower surface of the electrode assembly 10) and detect whether the separator 13 is folded based on a difference between a color value of the separator 13 and a color value of the electrode plates 11 and 12.

Specifically, the separator 13 may be detected as a color close to white by the color sensor, and the positive electrode plate 11 and the negative electrode plate 12 may be detected as a color close to black. Since the separator 13 wraps the outermost surface of the electrode assembly 10, especially, the lower surface (see FIG. 1), the lower surface of the electrode assembly 10 in which folding has not occurred may be detected as a color close to white.

If the separator is folded (f), the positive electrode plate 11 or the negative electrode plate 12 may be exposed to the lower portion of the electrode assembly 10 through the folded portion, which may be detected by the sensor unit 400.

In other words, when the sensor unit 400 detects a color close to black, the sensor unit 400 may generate a defect detection signal.

In addition, in an exemplary embodiment, the sensor unit 400 may extract the average of the overall color data values of the lower surface 10c of the electrode assembly 10 in which the separator folding f has not occurred, and if an average value of the color data closer to black than the average value is detected, the sensor unit 400 may determine that the structure has the separator folding (f).

When the sensor unit 400 includes a vision camera, the sensor unit 400 may track one end 10a of the electrode assembly 10, specifically, the edge portion, through the vision camera to determine whether the separator folding (f) has occurred.

The sensor unit 400 may compare an image captured by the vision camera with a previously stored image (an image of the electrode assembly in which separator folding has occurred or an image of the electrode assembly in which separator folding did not occur) to determine which of the images the captured image is close to.

Specifically, the sensor unit 400 may have pre-stored surface image data (data A) of the normal electrode assembly 10 and surface image data (data B) of the defective electrode assembly 10 in which separator folding (f) occurred. The sensor unit 400 may acquire surface image data (data C) of the electrode assembly 10, which is an determination target, in real time, and determine to which of data A or data B, data C is closer, to determine whether separator folding (f) has occurred.

Meanwhile, the sensor unit 400 may determine whether separator folding (f) has occurred, but the sensor unit 400 may acquire only the aforementioned data values and a determination process, such as comparing data, may be separately performed through a separate controller (not shown).

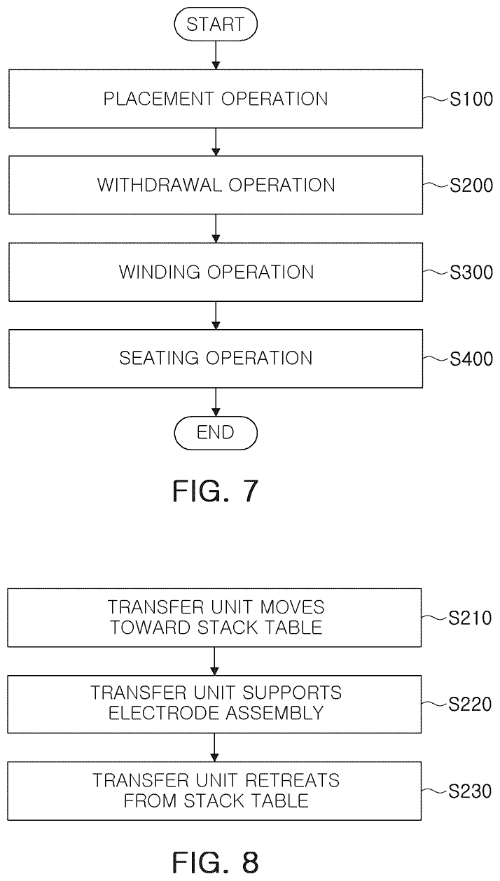

Meanwhile, FIGS. 7 to 10 illustrate a flowchart of a secondary battery manufacturing method according to an exemplary embodiment of the present disclosure.

Referring to FIG. 7, the secondary battery manufacturing method of the present disclosure may include a placement operation (S100) of locating the electrode assembly 10 on the stack table 100, a withdrawal operation (S200) of taking out the electrode assembly 10 from the stack table through the transfer unit 200, a winding operation (S300) of transferring the withdrawn electrode assembly 10 to the winding gripper 300, and a seating operation (S400) of seating the electrode assembly 10, on which winding is completed by the winding gripper 300, on the stack table 100 or an adjacent manufacturing apparatus again through the transfer unit 200.

The placement operation (S100) is an operation of placing the electrode assembly 10 on the stack table 100 (see FIG. 2A). In the placement operation (S100), the electrode assembly 10 may be disposed to be supported across the first table 110 and the second table 120. In particular, as shown in FIG. 2A, the electrode assembly 10 may be seated on the stack table 100 to overlap both table avoidance portions 105.

The withdrawal operation (S200) may refer to an operation of taking out the electrode assembly 10 from the stack table 100 through the transfer unit 200 (see FIGS. 2 and 3).

FIG. 8 is a detailed flowchart of the withdrawal operation. The process of withdrawing the electrode assembly 10 from the stack table 100 through the transfer unit 200 has been described in detail in FIGS. 2 and 3, so a redundant description will be omitted.

The withdrawal operation (S200) may include a first withdrawal operation (S210) in which the transfer unit 200 advances toward the stack table 100, a second withdrawal operation (S220) in which the transfer unit 200 supports the electrode assembly 10, and a third withdrawal operation (S230) in which the transfer unit 200 retreats from the stack table 100 and removes the electrode assembly 10.

In the first withdrawal operation (S210), the second table 120 may be lowered. The pulling jigs 210 and 220 may enter to support at least a portion of a region (second support region) supported by the second table 120. The support member 250 may move toward the table avoidance portion 105 formed in the first table 110 (see FIGS. 2A and 3A).

In the second withdrawal operation (S220), the pulling jigs 210 and 220 may approach each other in a direction in which they face each other to allow the electrode assembly 10 to be inserted therebetween. In addition, the support member 250, while raised by passing through the avoidance portion 305, may support the lower surface of the electrode assembly 10.

That is, in the second withdrawal operation (S230), the pulling jigs 210 and 220 and the support member 250 may support the electrode assembly 10 in different regions (see FIGS. 2B, 3B to 3D).

In the third withdrawal operation (S230), the pulling jigs 210 and 220 and the support member 250 may retreat in a direction opposite to the approach direction and escape from the stack table 100 together with the electrode assembly 10 (see FIGS. 2C and 3E).

In this process, the support member 250 may support one end 10a of the electrode assembly 10, specifically, the edge portion in which the table avoidance portion 105 is formed.

Through this, the secondary battery manufacturing method of the present disclosure may prevent the separator folding f of the electrode assembly 10 from occurring as much as possible until the electrode assembly 10 is taken out by the transfer unit 200.

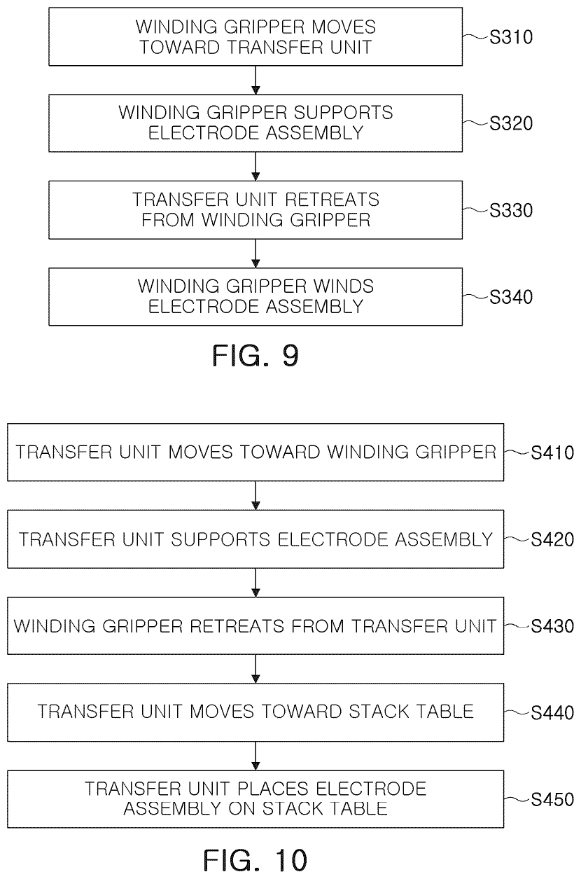

FIG. 9 is a detailed flowchart of the winding operation (S300). The process of transferring the electrode assembly 10 from the transfer unit 200 to the winding gripper 300 has been described in detail in FIGS. 4 and 5, so a redundant description thereof will be omitted.

The winding operation (S300) is one of the secondary battery manufacturing processes of the present disclosure and may refer to a process of rotating the electrode assembly 10 by 180 degrees or more through the winding gripper 300 to wrap the outermost portion of the electrode assembly 10 with the separator 13 one or more turns (see lower drawing of FIG. 1).

The winding operation (S300) may include a first winding operation (S310) in which the winding gripper 300 approaches the transfer unit 200 after the withdrawal operation (S200), a second winding operation (S320) in which the winding gripper 300 supports the electrode assembly 10, and a third winding operation (S330) in which the transfer unit 200 retreats away from the winding gripper 300 and the electrode assembly 10.

The first winding operation (S310) is an operation in which the winding gripper 300 approaches the transfer unit 200. The transfer unit 200 may advance and retreat in the width direction (Y-axis direction) of the electrode assembly 10, and the winding gripper 300 may approach and retreat in the longitudinal direction (X-axis direction) perpendicular thereto.

In the first winding operation (S310), the winding gripper 300 may be spaced apart from the support member 250 in the width direction (Y-axis direction) to approach in order to not overlap the support member 250 based in the longitudinal direction (X-axis direction) of the electrode assembly 10 in order to avoid interference with the support member 250 (see FIG. 4A).

The first winding operation (S310) may be performed until the gripper avoidance portion 305 and the support member 250 overlap in the width direction (Y-axis direction) as the winding gripper 300 approaches.

The second winding operation (S320) may be an operation in which the winding gripper 300 supports both the upper and lower surfaces of the electrode assembly 10. Specifically, a state in which the gripper avoidance portion 305 of the winding gripper 300 is disposed to overlap the support member 250 based on the height direction (Z-axis direction) is defined as a state in which ‘the winding gripper 300 supports the electrode assembly 10’.

In the second winding operation (S320), the winding gripper 300 may move in the width direction (Y-axis direction) perpendicular to the approach direction (length direction or X-axis direction) and may move until the gripper avoidance portion 305 overlaps the support member 250 in the height direction (Z-axis direction) (see FIGS. 4B and 5A). That is, the winding gripper 300 may continue to move until the support member 250 is disposed on the gripper avoidance portion 305.

Meanwhile, in FIG. 5A, the winding gripper 300 is illustrated to move in the width direction (Y-axis direction) while supporting the upper and lower surfaces of the electrode assembly 10, but this is only an example. For example, after the first grip portion 310 and the second grip portion 320 of the winding gripper 300 may be disposed below and above the electrode assembly 10, respectively, the gripper avoidance portion 305 may be disposed to overlap the support member 250, and then, the first grip portion 310 and the second grip portion 320 may be provided to support the lower and upper surfaces of the electrode assembly 10, respectively, while approaching each other.

When second winding operation (S320) is performed, the electrode assembly 10 may be supported by the pulling jigs 210 and 220, the support member 250, and the winding gripper 300 of the transfer unit 200.

The third winding operation (S330) may refer to a process in which the transfer unit 200 releases the support state of the electrode assembly 10 and returns to its original position. In the third winding operation (S330), the pulling jigs 210 and 220 may be separated from each other and the support member 250 may be lowered downwardly to release the support state. Next, the transfer unit 200 may escape from the electrode assembly 10 and the winding gripper 300, while retreating in the direction opposite to the direction (−Y-axis direction) in which the transfer unit 200 advanced (see FIGS. 4C and 5B to 5C).

Meanwhile, in the first winding operation (S310) described above, the edge portion of one end 10a of the electrode assembly 10 may be supported by the support member 250, in the second winding operation (S320), the edge portion may be supported by the support member 250 and the winding gripper 300, and in the third winding operation (S330), the edge portion may be supported by the winding gripper 300.

That is, since the edge portion of the electrode assembly 10 described above continues to be supported in the first to third winding operations (S310 to S330), sagging due to gravity may be prevented, and thus, the separator 13 may be prevented from being folded.

In addition, the winding operation (S300) may further include a fourth winding operation (S340) in which the winding gripper 300 rotates 180 degrees or more to wrap the separator 13 around the outermost portion of the electrode assembly 10.

The fourth winding operation (S340) may include a process in which the first grip portion 310 and the second grip portion 320 rotate by 180 degrees or more based on an axis parallel to the longitudinal direction (X-axis direction), while supporting the lower and upper surfaces of the electrode assembly 10, respectively. In this state, as illustrated in the lower drawing of FIG. 1, the separator 13 may wrap the outermost portion of the electrode assembly 10 one or more turns.

When the fourth winding operation (S340) is completed, one end 10a portion of the electrode assembly 10 may be wrapped by the separator 13 and is tensioned along an axis (axis parallel to the Y axis) perpendicular to the rotation axis (see the lower drawing in FIG. 1).

Accordingly, when the fourth winding operation (S340) is completed, one end 13a of the separator 13 is supported by the structure in which the separator 13 is wound, and thus, the phenomenon of the separator 13 sagging due to gravity may be prevented.

FIG. 10 is a detailed flowchart of the seating operation (S400). The seating operation (S400) may be an operation in which the electrode assembly 10, on which the winding operation (S300) has been completed, is transferred back to the stack table 100. Since this process may be the reverse order of the placement operation (S100), the withdrawal operation (S200), and the winding operation (S300) described above, a redundant description thereof will be omitted.

The seating operation (S400) may include a first seating operation (S410) in which the transfer unit 200 advances toward the winding gripper 300, a second seating operation (S420) in which the transfer unit 200 supports the electrode assembly 10, a third seating operation (S430) in which the winding gripper retreats from the transfer unit, a fourth seating operation (S440) in which the transfer unit 200 advances to the stack table 100, while supporting the electrode assembly 10, and a fifth seating operation (S450) in which the transfer unit 200 seats the electrode assembly on the stack table 100.

The first seating operation (S410) to the fifth seating operation (S450) may be an operation of transferring the electrode assembly 10 supported on the winding gripper 300 back to the seating table 100 and may be performed in the reverse order of the withdrawal operation (S200) and the winding operation (S300, except for the fourth winding operation S340) described above.

Specifically, the first seating operation (S410), the second seating operation (S420), and the third seating operation (S430) may be sequentially in the reverse order of the third winding operation (S330), the second winding operation (S320), and the first winding operation (S310), respectively. In addition, the fourth seating operation (S440) may be in the reverse order of the third withdrawal operation (S230), and the fifth seating operation (S450) may be in the reverse order of the second withdrawal operation (S220) and the first withdrawal operation (S210).

In this manner, in the secondary battery manufacturing method of the present disclosure, the edge portion of the electrode assembly 10 may be continuously supported from the placement operation (S100) to the winding operation (S300).

In addition, in the seating operation (S400) in which the electrode assembly 10, on which the winding has been completed, is transferred back to the stack table 100, the edge portion of the electrode assembly 10 may be continuously supported in the same manner.

Through this, in the secondary battery manufacturing method of the present disclosure, while the transfer unit 200 transfers the electrode assembly 10 to an adjacent manufacturing device (e.g., stack table 100 or winding gripper 300), the edge portion of the electrode assembly 10 may be continuously supported, thereby minimizing sagging of the edge portion of the electrode assembly 10, especially, separator folding (f), during the continuous manufacturing process.

The secondary battery manufacturing apparatus according to an exemplary embodiment of the present disclosure may support the separator from sagging downwardly due to gravity.

The secondary battery manufacturing apparatus according to an exemplary embodiment of the present disclosure may effectively sense the occurrence of separator folding.

The secondary battery manufacturing method according to an exemplary embodiment of the present disclosure may prevent the separator from sagging downwardly due to gravity during the secondary battery manufacturing process.

Only specific examples of implementations of certain embodiments are described. Variations, improvements and enhancements of the disclosed embodiments and other embodiments may be made based on the disclosure of this patent document.

What is claimed is:

1. A secondary battery manufacturing apparatus comprising:
a stack table supporting a first surface of an electrode assembly including at least one positive electrode plate, at least one negative electrode plate, and a separator interposed between the positive electrode plate and the negative electrode plate; and
a transfer unit transferring the electrode assembly while moving relative to the stack table and including a pulling jig supporting the first surface of the electrode assembly or a second surface facing the first surface,
wherein the transfer unit further includes a support member provided to support a portion of the first surface of the electrode assembly that is not supported by the pulling jig.

2. The secondary battery manufacturing apparatus of claim 1, wherein the support member is provided to be movable up and down toward the first surface.

3. The secondary battery manufacturing apparatus of claim 1, wherein the support member is provided to support at least first end of the electrode assembly based on a first direction.

4. The secondary battery manufacturing apparatus of claim 3, wherein the support member is provided to support an edge portion of the electrode assembly provided close to a second direction perpendicular to the first direction.

5. The secondary battery manufacturing apparatus of claim 1, wherein
the transfer unit is provided to advance or retreat with respect to the stack table in a first direction, and
the stack table includes a table avoidance portion formed in a position corresponding to the support member in the first direction and provided in a shape open toward the support member to avoid interference with the support member.

6. The secondary battery manufacturing apparatus of claim 5, wherein the stack table includes a first table at least partially facing the support member in the first direction and including the table avoidance portion and a second table at least partially facing the pulling jig in the first direction.

7. The secondary battery manufacturing apparatus of claim 6, wherein
the second table is provided to be movable up and down toward the first surface of the electrode assembly, and
the pulling jig is provided to move toward the stack table to support the electrode assembly when the second table is lowered.

8. The secondary battery manufacturing apparatus of claim 5, further comprising:
a winding gripper supporting a portion of the electrode assembly that is not supported by the pulling jig,
wherein the winding gripper is provided to be movable, relative to the transfer unit in a second direction perpendicular to the first direction.

9. The secondary battery manufacturing apparatus of claim 8, wherein the winding gripper includes a first grip body and a second grip body respectively supporting the first end and a second end of the electrode assembly based on the first direction.

10. The secondary battery manufacturing apparatus of claim 8, wherein the winding gripper includes a gripper avoidance portion formed in a portion overlapping the support member and provided to avoid interference with the support member.

11. The secondary battery manufacturing apparatus of claim 1, further comprising a sensor unit acquiring image information of the first surface of the electrode assembly and determining whether the first surface is wrinkled or folded.

12. The secondary battery manufacturing apparatus of claim 11, wherein the sensor unit includes at least one of a color sensor or a vision camera, and determine whether the first surface is folded by tracking an edge of the first surface of the electrode assembly and comparing color values of a folded portion and other portions.

13. A secondary battery manufacturing method comprising:
a placement operation of placing, on a stack table, an electrode assembly including at least one positive electrode plate, at least one negative electrode plate, and a separator interposed between the positive electrode plate and the negative electrode plate; and
a withdrawal operation in which the transfer unit draws out the electrode assembly from the stack table, while the transfer unit moves relative to the stack table in a first direction,
wherein the withdrawal operation includes:
a first withdrawal operation in which the transfer unit advances toward the stack table in the first direction;
a second withdrawal operation in which the transfer unit supports the electrode assembly; and
a third withdrawal operation in which the transfer unit retreats from the stack table together with the electrode assembly in the first direction.

14. The secondary battery manufacturing method of claim 13, wherein
the transfer unit includes a pulling jig supporting the electrode assembly and a support member supporting a portion of the electrode assembly that is not supported by the pulling jig, and
in the second withdrawal operation, the pulling jig and the support member support the electrode assembly.

15. The secondary battery manufacturing method of claim 14, wherein
the stack table includes a first table facing the support member in the first direction and a second table facing the pulling jig in the first direction and provided to be movable up and down with respect to the electrode assembly, and
in the first withdrawal operation, the second table is lowered, and in the third withdrawal operation, the second table is raised.

16. The secondary battery manufacturing method of claim 14, further comprising:
after the withdrawal operation, a winding operation in which a winding gripper supports the electrode assembly, while moving relatively toward the transfer unit,
wherein the winding operation includes:
a first winding operation in which the winding gripper approaches the transfer unit in a second direction perpendicular to the first direction;
a second winding operation in which the winding gripper supports a portion of the electrode assembly that is not supported by the pulling jig; and
a third winding operation in which the pulling jig and the support member release support of the electrode assembly and retreat from the winding gripper along the first direction.

17. The secondary battery manufacturing method of claim 16, wherein,
in the first winding operation, the winding gripper moves in the second direction so as not to overlap the support member, and
in the second winding operation, the winding gripper is provided to move in the first direction so that the support member is disposed in a gripper avoidance portion.
